(19) United States
(12) Patent Application Publication
(10) Pub. No.: US 2008/0241325 A1
(43) Pub. Date: Oct. 2, 2008

(54) Device and Method for Removing Liquid From a Food Strand

(75) Inventor: Adrianus Johannes Maria Reijers, Oss (NL)

Correspondence Address: ZARLEY LAW FIRM P.L.C., CAPITAL SQUARE, 400 LOCUST, SUITE 200, DES MOINES, IA, 50309-2350, US

(73) Assignee: STORK TOWNSEND B.V., Oss (NL)

(21) Appl. No.: 11/718,322

(22) PCT Filed: Oct. 20, 2005
(86) PCT No.: PCT/NL05/50019

§ 371 Date: Sep. 12, 2007

(30) Foreign Application Priority Data
Oct. 22, 2004 (NL) 1027318

(51) Int. Cl. A23L 1/00; A47J 43/00

(52) U.S. Cl. 426/474; 99/495

(57) ABSTRACT

The invention relates to a device for removing liquid, and more particularly a salt solution, from the surface of a food strand, such as for instance a sausage strand, during displacement of the food strand. The invention also relates to a method for removing liquid from the surface of a food strand.

The invention relates to a device for removing liquid from the surface of a food strand during displacement of the food strand. The invention also relates to a method for removing liquid from the surface of a food strand.

In the production and processing of a food strand, such as for instance an extruded sausage strand, processes take place wherein the food strand is treated with a liquid. Examples of such processes are treating with a coagulation liquid a top layer of a sausage strand for coagulating, treating a sausage strand with a liquid smoke, rinsing a food strand and so on. In order to prevent a liquid applied in such a process from having an adverse effect, it may be desirable under determined conditions to remove the excess liquid and/or liquid remaining on the surface. A food strand can thus for instance be dried more quickly, undesirable substances can be kept off the surface, and it is possible to prevent the liquid having an undesired effect on subsequent processes, and so on.

According to the prior art known from U.S. Pat. No. 5,997,919, liquid such as a coagulation liquid can be removed from a food strand by caring the food strand through an opening in a flexible body. The flexible material must herein engage on the food strand with some resilience so that the liquid is brushed or scraped from the sausage strand. This technique has the advantage that it is possible to remove the liquid adhering to the sausage strand very effectively. A significant drawback of the use of a flexible scraping body is however that a sausage strand can become jammed in the opening in the flexible body. Where there is a constant supply of the strand, this jamming of the strand in the opening can result in great contamination of the equipment, and a considerable loss of product will also occur. The prior art device is also less suitable for processing a food strand with varying cross-sectional dimensions, or it is difficult to process food strands of different dimensions on a device.

The present invention therefore has for its object to provide an improved method and device for efficiently removing adhering liquid from a food strand without the relatively high possibility of disruptions with associated serious consequences as according to the prior art.

The invention provides for this purpose a device for removing liquid from the surface of a food strand, comprising: transport means for displacing the food strand over a transport route and supply means for gas placed adjacently of the transport route, wherein the supply means for gas are adapted to generate a plurality of gas flows crossing the transport route successively in the direction of transport. According to the present invention the liquid is blown off with a plurality of gas flows instead of with a mechanical engagement on the food strand as according to the prior art. The gas flows come into contact with the food strand whereby they entrain, or at least blow off, at least a fraction of the moisture adhering to the food strand. In order to obtain the best possible result the food strand is carried successively through a plurality of gas flows. It is possible here to envisage two or three separate gas flows, but it is also possible to apply tens of gas flows (for instance fifty). An effective result can thus also be achieved by blowing off liquid. The device can be provided with a common frame for the transport means and the supply means for gas. In respect of the transport means, it is possible to opt for an endless conveyor belt with a drive engaging thereon, or another conveyor such as is already applied for displacing food strands, although it is also possible to displace the food strand over a distance in freely suspended manner, or to give the conveyor a form such that it engages the food strand on only a small surface and thus makes the food strand readily accessible by the gas flows. Another important advantage of the present invention is that it is also possible to remove the liquid from at least a part of the transport means for the food strand (such as a belt or chain).

In a preferred variant the supply means for gas comprise a number of mutually separated blow openings, which blow openings can for instance be fed in simple manner from a central gas supply. In addition to the function of removing liquid, the supplied gas can also fulfil an extra (conditioning) function depending on the chosen gas composition, such as for instance an antibacterial function. On the other hand it is also possible for the supply means for gas to supply air (blow air) which is supplied under overpressure by for instance a blower or fan.

In a particular preferred embodiment the device is also provided with collecting means for collecting the liquid removed from the food strand by the gas flows. It is thus possible to prevent the liquid removed from the strand contaminating the environment or, depending on the conditions, the liquid can even be re-used. The device can even be expanded such that it is also provided with supply means for liquid which are upstream of the supply means for gas and placed adjacently of the transport route and with which liquid can be brought into contact with the food strand. The whole path of the (liquid) processing of the strand thus takes place in a single device, which increases the control over such a (liquid) processing. If the device is also provided with a housing enclosing the supply means for liquid and the collecting means for the removed liquid, the whole (liquid) processing then takes place within the same housing, which results in a very small chance of disruption of the processes and of contamination of the environment. It is for instance possible here to envisage a highly osmotic liquid in the form of a salt solution (examples hereof are salt solutions such as solutions with DKP, NaCl or other salts) wherein the solution is blown off in the cabinet in which the bath is arranged. The entraining of the solution can thus be countered, which is also advantageous for a treatment with for instance liquid smoke to be performed afterward. The discharge of the adhering liquid moreover enhances the flavour of the food.

Even more additional effects can be obtained if the supply means for gas comprise heating means and/or cooling means. A heating and/or cooling process of the sausage strand can thus take place simultaneously with the removal of the liquid. A further advantage of applying a heating element is that the gases for supplying can be bacterially cleaned therewith (heated above a minimum temperature). Yet another manner of achieving this cleaning effect is by treating the gases for supplying with (UV) radiation.

In an embodiment variant which is easy to realize and manage, the supply means for gas are formed by a hollow transport body for gas which is placed substantially parallel to the transport route and in which a plurality of outlet openings are arranged Such a body can for instance consist of a pipe or a tube in which placed-apart slots or outlet openings of other form are arranged. The outlet openings can be provided with an adjustable passage opening and/or a nozzle, the outflow direction of which is adjustable. The body can have an optimum length, which partly depends on a number of variables such as the advancing speed of the food strand, of several tens of centimetres, one metre or even a number of metres.

The invention also provides a method for removing liquid from the surface of a food strand by carrying the food strand successively through a plurality of gas flows. Particularly favourable results are achieved if the food strand undergoes varying flow conditions while being carried through the gas flows. Such varying flow conditions can be related to one or more of the following variables: speed, temperature, direction, gas composition and turbulence. A simple manner of obtaining varying flow conditions is by carrying the food strand successively through a gas flow and a segment with a substantially stationary gas condition.

When liquid is removed from a sausage strand it is desirable that the flow rate of the gas flow at least at one location amounts to at least 5 metres per second. The food strand is preferably also situated in such a gas flow for 1-10 s.

The present invention will be further elucidated on the basis of the non-limitative exemplary embodiments shown in the following figure. Herein:

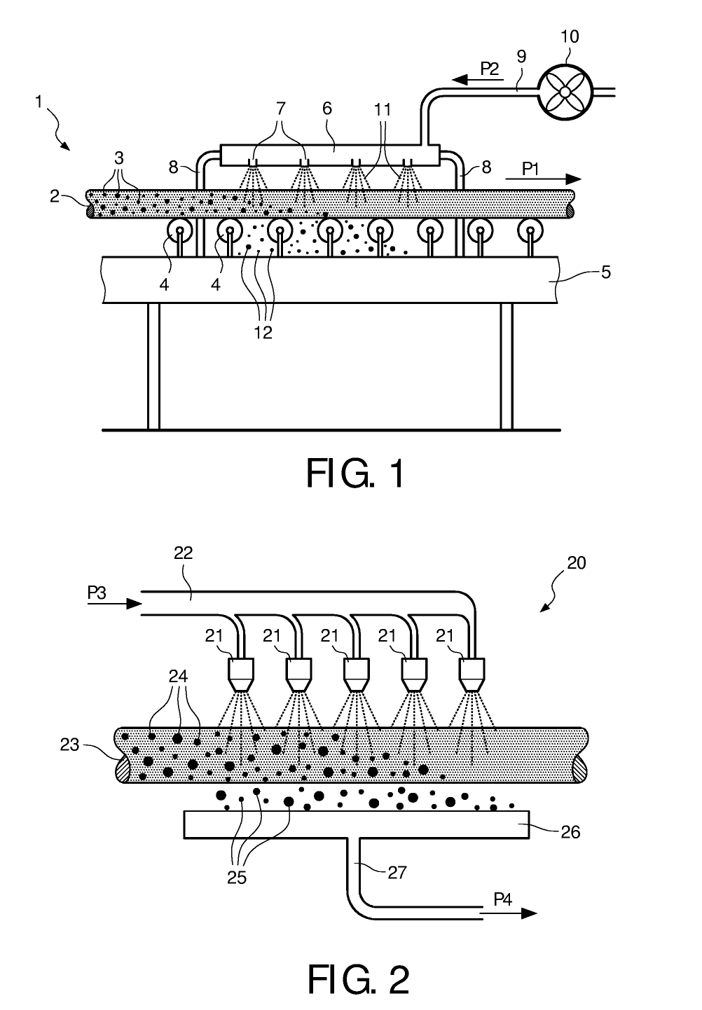

FIG. 1 shows a cross-section through a device according to the invention,

FIG. 2 shows a cross-section through a part of an alternative embodiment variant of the device according to the invention,

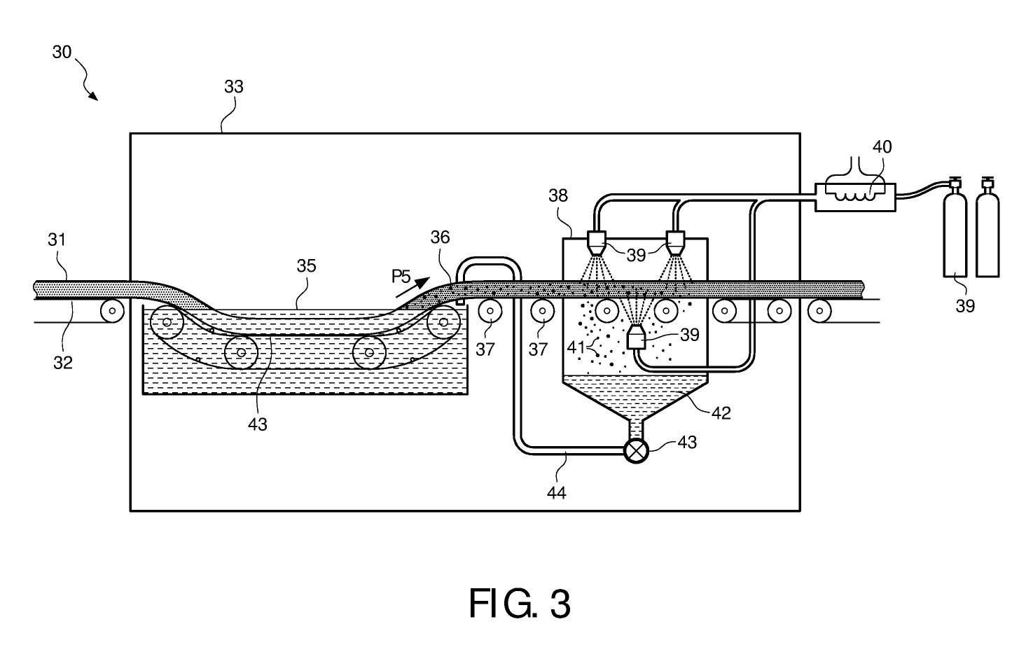

FIG. 3 shows a cross-section through a second embodiment variant of a device according to the invention for wetting and drying a food strand, and

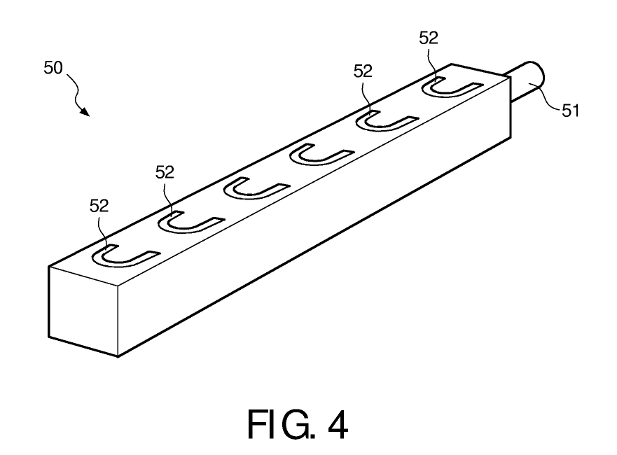

FIG. 4 shows a perspective view of a nozzle for use in the device according to the invention.

FIG. 1 shows a device 1 for removing liquid 3 adhering externally to a sausage strand 2. Sausage strand 2 is advanced by a roller conveyor 4 in a transport direction P1. Roller conveyor 4 is supported by a frame 5. Disposed parallel to sausage strand 2 is a housing 6 in which a number of openings 7 are arranged. Pipe 6 is connected to frame 5 with brackets 8. Connecting onto pipe 6 is a conduit 9 through which air supplied by a fan 10 is blown to the pipe 6 as according to arrow P2. As a result of the supply of air to pipe 6, a number of successive gas flows 11 are created in the direction of transport of sausage strand 2, whereby the liquid 3 is blown from strand 2 in a number of phases and falls downward in the form of drops 12.

FIG. 2 shows a part of a device 20 with a number of blow nozzles 21 which are supplied with a gas as according to arrow P3 by a pipe system 22. The liquid 24 adhering to a sausage strand 23 is thus blown off by nozzles 21. The liquid 24 removed from strand 23 falls in the form of drops into a collecting vessel 26 from which the collected liquid is drained as according to arrow P4 through an outlet 27.

FIG. 3 shows a device 30 to which a sausage strand 31 is supplied by a conveyor belt 32. Device 30 is enclosed by a housing 33 so that device 30 can function without disturbing influences from outside and without having an impact on the environment. The strand 31 carried into housing 33 and supported by an endless conveyor belt 34 enters a brining bath 35 (or, alternatively, a liquid smoke bath). The strand 31 leaves bath 35 as according to arrow P5 in a state in which the outside of strand 31 entrains adhering liquid 36. After being supported by a pair of rollers 37, the wet strand 31 enters a chamber 38 in which nozzles 39 blow a gas against strand 31 from different sides. The gas comes from a gas bottle 39 and is first brought to the desired temperature by a temperature regulator 40 before reaching nozzles 39. The liquid droplets 41 blown from the strand 31 by nozzles 38 fall into a reservoir 42 and are pumped back to bath 35 by a pump 43 and a return conduit 44. Finally, the dried strand 31 leaves housing 33 of device 30.

FIG. 4 finally shows a tube 50 with a connection 51 for the supply of a gas. Recessed into the tube are slots 52, through which the gas supplied through connection 51 can once again escape. Using tube 50 a number of successive and mutually separated gas flows can be realized in simple manner. Gas flows generated in this manner are also referred to as gas or air knives.

1. Device (1, 20, 30) for removing liquid (3, 24, 36) from the surface of a food product (2, 23, 31), comprising:
transport means (4; 37) for displacing the food product (2, 23, 31) over a transport route, and
supply means for gas (6, 7; 21, 22; 39; 50) placed adjacently of the transport route, characterised in that the supply means for gas (6, 7; 21, 22; 39; 50) are adapted to generate a plurality of gas flows (11) crossing the transport route successively in the direction of transport and in that the transport means (4, 37) are adapted to supply a food strand (2, 23, 31).

2. Device (1, 20, 30) as claimed in claim 1, characterized in that the supply means for gas (6, 7; 21, 22; 39; 50) comprise a number of mutually separated blow openings (7, 21, 39, 52).

3. Device (1, 20, 30) as claimed in claim 1, characterized in that the supply means for gas (6, 7; 21, 22; 39; 50) are provided with a central gas supply (9, 10; 45; 51).

4. Device (1, 20, 30) as claimed in claim 1, characterized in that the device (1, 20, 30) is also provided with collecting means (26) for the liquid (12, 25, 41) removed from the food strand (2, 23, 31) by the gas flows (11).

5. Device (1, 20, 30) as claimed in claim 1, characterized in that the device (1, 20, 30) is also provided with supply means (35, 42) for liquid (3, 24, 36) which are upstream of the supply means for gas (6, 7; 21, 22; 39; 50) and placed adjacently of the transport route and with which liquid (3, 24, 36) can be brought into contact with the food strand (2, 23, 31).

6. Device (1, 20, 30) as claimed in claim 5, characterized in that the device (1, 20, 30) is also provided with a housing (33) enclosing the supply means (35) for liquid (3, 24, 36), which housing (33) also comprises collecting means (26, 42) for collecting the removed liquid (12, 25, 41).

7. Device (1, 20, 30) as claimed in claim 1, characterized in that the supply means for gas (6, 7; 21, 22; 39; 50) supply air.

8. Device (1, 20, 30) as claimed in claim 1, characterized in that the supply means for gas (6, 7; 21, 22; 39; 50) comprise heating means (40).

9. Device (1, 20, 30) as claimed in claim 1, characterized in that the supply means for gas (6, 7; 21, 22; 39; 50) comprise cooling means (40).

10. Device (1, 20, 30) as claimed in claim 1, characterized in that the supply means for gas (6, 7; 21, 22; 39; 50) comprise a hollow transport body for gas (6, 50) which is placed substantially parallel to the transport route and in which a plurality of outlet openings (7, 52) are arranged.

11. Method for removing liquid (3, 24, 36) from the surface of a food product (2, 23, 31), characterised in that the food product (2, 23, 31) is supplied as a food strand (2, 23, 31), which food strand (2, 23, 31) is successively carried through a plurality of gas flows (11).

12. Method as claimed in claim 11, characterized in that the food strand (2, 23, 31) undergoes varying flow conditions while being carried through the gas flows (11).

13. Method as claimed in claim 11, characterized in that the food strand (2, 23, 31) is carried successively through a gas flow (11) and a segment with a substantially stationary gas condition.

14. Method as claimed in claim 11, characterized in that the flow rate of the gas flow (11) amounts to at least 5 metres per second.
